(19) United States
(12) Patent Application Publication
(10) Pub. No.: US 2011/0138919 A1
(43) Pub. Date: Jun. 16, 2011

(54) METHOD AND DEVICE FOR THE NON-DESTRUCTIVE ULTRASONIC TESTING OF A TEST PIECE WITH FLAT SURFACES AT AN ANGLE TO EACH OTHER

(75) Inventors: Stephan Falter, Simmerath (DE); Dieter Lingenberg, Hurth (DE); Gerald Rosemeyer, Euskirchen (DE); Cord Asche, Hurth (DE)

(73) Assignee: GE SENSING & INSPECTION TECHNOLOGIES GMBH, HURTH (DE)

(21) Appl. No.: 12/993,245

(22) PCT Filed: May 28, 2009
(86) PCT No.: PCT/EP2009/056569

§ 371 Date: Feb. 23, 2011

(30) Foreign Application Priority Data
May 29, 2008 (DE) 10 2008 025 903.9
Jun. 6, 2008 (DE) 10 2008 027 228.0

(51) Int. Cl. G01N 29/07

(52) U.S. Cl. 73/597

(57) ABSTRACT

The invention relates to a method for the non-destructive ultrasonic testing of a test piece (3) with flat surfaces (5) at an angle to each other by means of several selectively activatable ultrasonic transducers (2, 2′, 2″), whereby the method comprises several test cycles, with which certain (2,2″) of the several ultrasonic transducers (2, 2′,2″) are selected and activated, in order to emit at least one ultrasonic pulse (7, 7″) to the test piece, and with which the ultrasonic pulse reflected in the test piece (3) is received by the selected and/or, if necessary, other ultrasonic transducers (2, 2′, 2″). The method according to the present invention is characterized in that in the respective test cycle, the determined ultrasonic transducers (2, 2″) are so selected and activated, that the main propagation direction (6, 6″) of the ultrasonic pulse (7, 7″) produced by the selected and activated ultrasonic transducers (2, 2″) is perpendicular to at least one of the angled surfaces (5) of the test piece (3). The invention also relates to an associated device and ultilization.

The invention relates to a method and an associated device for the non-destructive ultrasonic testing of a test piece with flat surfaces at an angle to each other by means of several selectively activatable ultrasonic transducers, whereby the method comprises several test cycles, with which certain of the several ultrasonic transducers are selected and activated, in order to emit at least one ultrasonic pulse to the test piece, and with which the ultrasonic pulse reflected in the test piece is received by the selected and/or, if necessary, other ultrasonic transducers.

Ultrasonic testing is an appropriate method of testing with sound-conductive materials (including most metals) for the discovery of internal and external faults, for example, with welding seams, forgings, casting, semi-finished products or pipes. Like all methods of testing, the ultrasonic inspection is also standardized and is performed according to guidelines, for example, according to the DIN EN 10228-3 1998-07 Non-Destructive Testing of Forgings of Steel—Part 3:: Ultrasonic Testing of Forgings of Ferritic and Martensitic Steel, which is included herewith by reference. Suitable testing sets and methods are known for the non-destructive testing of a test piece by ultrasound. Reference is quite commonly made to the textbook of J. and H. Krautkrämer ISBN, Materials Testing with Ultrasound, sixth edition.

This method is commonly based on the reflection of sound to bounding surfaces. As the sound source, one uses mostly a probe with one or two ultrasonic transducers, whose sound radiation lies in each case in the frequency range of 10 kHz to 100 MHz. With pulse echo methods the ultrasonic transducer emits no continuous radiation, but rather very short acoustic pulses, whose duration is 1 ps and less. The pulse emanating from the transmitter passes through the test piece to be tested with the appropriate sound velocity and is reflected almost completely to the bounding surface metal-air. The sonic transducer can for the most part emit not only pulses, but rather also convert in-coming pulses into electrical measuring signals; thus it also operates as a receiver. The time, which the acoustic pulse needs, in order to come from the transmitter through the workpiece and back again is measured with an oscilloscope or a computer unit. With known sound velocity c in the material, the thickness of a sample can be tested in this manner, for example. For the coupling between workpiece and ultrasonic transducer, a coupling means (for example, paste (solution), gel, water or oil) is applied to the surface of the workpiece to be tested. With a relative movement between transducer and test piece for the purpose of transfer of the acoustic signal, the test piece is often immersed in an appropriate fluid (immersion technique), or defined wetted.

Through changes of the acoustic properties at bounding surfaces, i.e., at the external wall surfaces limiting the test piece, but also at the internal bounding surfaces, i.e., faults in the interior, such as a cavity (hollow space), at an enclosure, a lamination, a crack or another separation in the structure in the interior of the workpiece to be tested, the acoustic pulse is reflected and sent back to the transducer in the probe, which acts both as the transmitter and also as the receiver. The elapsed time between the sending and reception permits the calculation of the path. By means of the measured time difference, a signal image is produced and is made visible on a monitor or oscilloscope. By means of this image, the status of the change of the acoustic properties of the test piece can be determined and, if necessary, the size of the fault (in technical language also referred to as “discontinuity”) can be assessed. With automatic test rigs, the information is stored, put into perspective for the test piece and documented in different ways immediately or later.

With the classical method for the non-destructive ultrasonic testing of round steel and pipes as test pieces, either the mechanically rotating probes or film probes overlapping in the sound field are used, which frequently requires a high apparatus expense. Therefore, an alternative method for the testing of pipes or round rods in “phased-array technique” was developed by the applicant of the present invention. With the “phased-array technique,” one or several antenna arrays of a plurality of selective phase-activatable transducers are used as a probe (so-called “phased-array”-probe). The respective antenna array consists, for example, of 128 individual ultrasonic transducers each, whereby each individual transducer is connected electrically by cable and is selectable. Thus, each trans-ducer can be activated as an ultrasonic transmitter and furthermore can be used as a receiver. For the intromission of sound into the pipe or the test piece, up to, for example, 32 adjacent transducers are selected in order to form a “virtual” probe. By serial cycling through the transducer in the multiplex-method, a rotating sound field is produced. The “step size” of the cycle determines the virtual rotation velocity. Via the “delay-times” (phase displacements or delay times, for example, in nanoseconds), with which the transducers are activated for a virtual probe in a designated sequence, the sound field can be formed. Through this “electronic” form of the sound field it is possible, to produce a variable angle intromission of sound in the radial direction as well as a variable focusing of the sound field. After input of the parameters such as probe type, rod diameter, intromission sound angle in the rod, focus distance, etc. the known method calculates the necessary delay-times.

The method has the disadvantage, that in this previously known embodiment it is not suitable for the testing of test pieces with angled, flat surfaces, but rather in practice only for test pieces with round cross sectional area. The inventors of the present invention have recognized, that this is to be ascribed to the fact that based on a sound incidence not perpendicular to the respective surface of the test piece diffraction and refraction effects prevent a reproducible test result and/or—due to the arrangement of the angled, flat surfaces—an insufficient, because imcompete acquisition of the test piece interior occurs.

Against the background of this disadvantage, the inventors of the present invention have set for themselves the task of developing a method as well as a device for the non-destructive ultrasonic testing of a test piece with flat surfaces at an angle to each other, which is reliable and/or permits a more comprehensive testing of the test piece interior. This task is achieved through a method according to claim 1 as well as a device according to the coordinate claim. Advantageous embodiments are in each case the subject matter of the dependent claims.

The method according to the preseent invention serves the non-destructive ultrasonic testing of a test piece with flat surfaces at an angle to each other. The test piece is made of a sound-conductive material. With the test piece it is preferably a matter of a rod. Still more preferably in each case it has several, pairwise parallel surfaces. The method is carried out by means of several selectively activatable ultrasonic transducers. The transducers are thus separately electrically connected by cable and it is a matter, for example, of piezo- or film transducers. The selective controllability comprises the adjustability of the intensity of the ultrasonic pulse emitted by the transducer and/or of the phase displacement between the emitted pulses of the respectively selected ultrasonic transducers. Generally, due to the phase adjustment, any widely varied angle intromission of sound in the direction of the test piece as well as a widely varied adjustable focusing of the emitted sound field, or of the sound field lobe, is made possible.

The method according to the present invention comprises several test cycles, in which in each case certain of the several ultrasonic transducers (groups) are selected and activated, in order to transmit into the test piece at least one ultrasonic pulse, preferably several—depending on the desired resolution—in a frequency of typically 5 to 10 MHz. Furthermore, the ultrasonic pulse reflected in the test piece is received by the selected sending transducers and/or, if necessary, other ultrasonic transducers.

The method according to the present invention is characterized in that in the respective test cycle the ultrasonic transducers are selected and activated, so that the main propagation direction of the ultrasonic pulse produced by the selected and activated ultrasonic transducers is perpendicular to at least one of the angled surfaces of the test piece. Through the prevention of an angular acoustic irradition of the surfaces, diffraction and refraction effects on the bounding surface of the test piece interior are prevented, and the reliability and reproducibility of the fault recognition is increased. For this reason, the method is suited for the otherwise unfeasible testing of the test pieces with flat surfaces at an angle to each other, whereby the general advantages of the “phased-array-technique” persist particularly with regard to the conventional technology, which are here:
compact construction through simple mechanics
no mechanically rotating parts
short set-up times with profile change through electronic adjustment of the sound field formation (Set-up time: “Phased-array technique”<5 min; Rotation equipment 25-45 min)

In addition, the method according to the present invention of the perpendicular intromission of sound can be supplemented by an additional angle intromission of sound, i.e., an angular ultrasonic incidence on the respective surface, through the possible electronic sound field formation.

It rests with the person skilled in the art, to carry out the electronic sound field formation of the ultrasonic test procedure on a test body with specified flat-top borings of different sound paths, for example, under static conditons, in order to obtain specifications for the selection of the phase activation. The diameter of these flat-top borings are in general, depending on the specification, between 0.4 mm and ø 1.2 mm. One specification required for the testing is specified, for example, in the aviation requirement AMS-Std. 2154 Cl. AA.

With the method according to the present invention, the ultrasonic transducers are selected and activated preferably by means of the spatial arrangement of angled surfaces relative to the several ultrasonic transducers. For example, the calculation occurs before the performance of the sound irradiation for each of the transducers for preset points of impact of the ultrasonic pulse on the respective flat surfaces of the test piece. According to a further advantageous embodiment, the selection and activation is effected by means of a numerical algorithm, for example, according to Fermat's Principle. The numerical algorithm serves the precise determination of the desired sound field, which according to the present invention has a main propagation direction perpendicular to the respective surface, but furthermore—for example, depending on the desired depth of the testing in the interior of the test piece—can be arbitrarily focussed.

According to a further advantageous embodiment, a relative movement is provided in the longitudinal direction between the test piece during the test cycle or between (intermittent) the test cycles and the ultrasonic transducers while retaining the spatial alignment and the distance of its angled surfaces to the ultrasonic transducers. Thus, the test piece can be acquired more comprehensively in its longitudinal direction.

According to a further advantageous embodiment, the method comprises several time-sequential test cycles with main propagation directions parallel to each other testing different areas of the test piece. Thereby, a comprehensive acquisition and testing of the interior of the test piece for faults can be undertaken. The untested “boundary area” of the test piece necessarily present due to the edge-shaped transition to the respectively adjacent surface, can thus be minimized, since the respective flat surface in several test cycles is repeatedly penetrated perpendicularly at different penetration points of the ultrasound by the latter (and, for example, not only in the direction of the center point of the test piece).

In this way, the entire flat surface of the test piece is scanned. Thus, the reliability of the method according to the present invention for the non-destructive ultrasonic testing can clearly be increased.

In order to achieve as all-encompassing a testing of the test piece as possible in the circumferential direction of the test piece, in an advantageous embodiment the method according to the present invention comprises several time-sequential, but not mandatorily immediately successive test cycles for the testing of the test piece while rotating the main propagation direction in a circumferential direction of the test piece.

The invention relates to a device for the non-destructive ultrasonic testing of a tet piece in several test cycles, whereby the test piece has flat surfaces at an angle to each other. The device comprises the following: Several selectively activatable ultrasonic transducers, a selection unit for the selection of certain of the several ultrasonic transducers in each test cycle, a control unit for the activation of the selected ultrasonic transducers, in order to transmit at least one ultrasonic pulse, preferably a pulse sequence, into the test piece, and an evaluation unit for the receipt of the ultrasonic pulse reflected in the test piece through the selected and/or other ultasonic transducers for the transmission. The device is characterized in that the selection unit and/or the control unit are so designed, that in the respective test cycle the ultrasound transducers are selected and activated in such a way, that the main propagation direction of the ultrasonic pulse produced through the selected and activated ultrasonic transducers is perpendicular to at least one of the angled surfaces of the test piece.

Through the prevention of the angular sound irradiation of the surface, diffraction and refraction effects are prevented in the test piece interior, the reliability of the fault recognition is increased. For this reason, the device is suited for the otherwise unfeasible testing of test pieces with flat surfaces at an angle to each other, whereby the general advantages of the “phased-array-technique” persist particularly with regard to the conventional technology. In addition, the method according to the present invention of the perpendicular intromission of sound can be supplemented by an additional angle intromission of sound, i.e., an angular ultrasonic incidence on the respective surface, through the possible electronic sound field formation.

For the achievement of a reliable forecast concerning the main propagation direction of the produced sound cone and its point of impact on the relevant surface, the selection unit and/or the control unit are designed, so that the ultrasonic traducers are selected and activated by means of the spatial arrangement relationship of the angled surface to the several ultrasonic tranducers. Preferably, the selection and/or activation take place by means of a numerical algorithm, for example, according to Fermat's Principle.

For the most complete testing of the test body possible, for example, along its longitudinal direction, means are provided for the relative movement between the test piece during the test cycle or between the test cycles and the ultrasonic transducers. Furthermore, means are provided for the retention of the spatial alignment and the distance of its angled surfaces to the ultrasonic transducers, for example, at least one guide. For example, the test piece is moved through a fixed transducer arrangement, in order to avoid a mechanically complex construction for the movement of the transducer arrangement while maintaining its electrical contacting.

Preferably, the selection unit and the control unit are designed, so that several time-sequential test cycles are provided with main propagation directions parallel to each other for the testing of different areas of the test piece. Thereby, a comprehensive acquisition and testing of the interior of the test piece for faults is undertaken. The untested “boundary area” of the test piece necessarily present due to the edge-shaped transition to the respectively adjacent surface, can thus be minimized, since the respective surface in several test cycles is scanned by sound perpendicularly at different penetration points of the ultrasound and, for example, not only in the direction of the center point of the test piece. In this way, the entire flat surface of the test piece is scanned. Thus, the reliability of the method according to the present invention for the non-destructive ultrasonic testing can be increased.

In order to achieve as comprehensive as possible a testing of the test piece in a circumferential direction of the test piece, the selection unit and the control unit are designed, so that several time-sequential test cycles for the testing of the test piece are provided while “rotating” the main propagation direction in a circumferential direction of the test piece. Practically, this means, that a first flat peripheral surface while retaining the main propagation direction (see also perpendicular intromission of sound) is scanned from one “kink” to the other. With the change to the next (generally adjacent) peripheral surface, then the main propagation direction is suddently changed, in order to have perpendicular intromission of sound on this surface.

According to a preferred embodiment, the device for the non-destructive ultrasonic testing is shaped, so that the ultrasonic transducers are arranged ring-shaped, preferably spaced uniformly, around the test piece. In that the transducers are arranged ring-shaped, the transducer arrangement geometry is to a large extent test-piece neutral and the device suits it for the testing of the test pieces with virtually any cross sectional geometry. Thus, for example, also test pieces with round, but (known) cross section area can be tested. In the last case, moreover, the position of the test piece relative to the ultrasonic transducers must be known.

Preferably, for the acoustic coupling, a water quench is provided between the ultrasonic transducers and the surfaces of the test piece. The coupling of the ultra sound takes place in so-called immersion technique, preferably according to the so-called “ROWA”-Principle (Rotating Water Jacket). This method is described for example in DE 199 31 350 A1 and is especially suited for the coupling of rod-shaped moved test pieces. In the process, the transducers are located in a chamber, in which water is injected through tangentiallly applied nozzles. Thereby, a rotating water jacket (water pipe) emerges. The inner diameter of this water pipe is dependent on the quantity of the water, which is injected, and is adjusted, so that it is only slightly smaller than the diameter of the rod-shaped test body to be tested. Thus, with the intake of the rod-shaped test piece during the testing water, displacement hardly occurs and thus no disturbing air bubble inclusions or water turbulences, which could have a negative impact on the water coupling. The “ROWA”—Principle ensures extremely small untested ends with a length of 15-20 mm with a standard through-put speed of 0.8 m/sec.

The previously described device according to the present invention in one of its embodiments is used advantageously in the testing of a rolled product as test piece made of high-speed steel or tool steel. Due to the speed of the method, it can be used advantageously in the process of manufacture, in order to minimize the rejections and to accelerate the manufacturing process.

The invention relates also to an arrangement of a device for the non-destructive ultrasonic testing in one of the previously described embodiments and a test piece with angled surfaces. Preferably, with the test piece it is a matter of one with pairwise parallel surfaces, for example, a rod with 4, 6 or 8 edges or a flat bar. It can be a matter of a solid bar or a pipe. Preferably, the test piece is rod-shapd and the ultrasonic transducers are arranged in one or several planes perpendicular to the longitudinal axis of the rod-shaped test piece. The test piece is also preferably a rolled product made of high-speed steel or tool steel and has, for example, a material diameter of approx. 10 mm (rod) to 400 mm (pipe). In the following, the method according to the present invention is elucidated by means of some schematic figures, without the invention being limited to that which is shown.

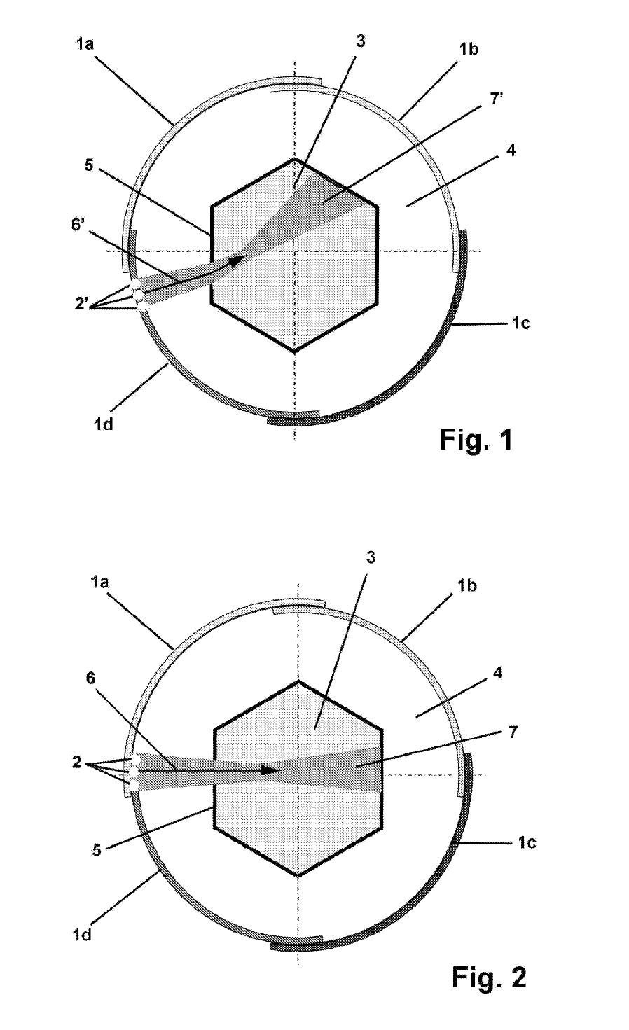

FIG. 1 shows a probe in cross section, which comprises four antenna arrays 1a, 1b, 1c, 1d forming a ring of several selective, phase-activatable transducers, for example, in each case 128. For reasons of clarity, merely the transducers active in the respective test cycle are indicated (here: 2′).

The probe 1a, 1b, 1c, 1d serves for the ultrasonic testing of a rod-shaped test piece 3, which comprises an even number, here: 6 of surfaces 5 arranged at an angle to each other, of which in each case two are parallel to each other. The test piece 3 is moved perpendicular to the paper plane, in order to test it in the longitudinal direction. Several of the ultrasonic transducers of the antenna arrays 1a, 1b, 1c, 1d can be selected in a test cycle and activated phase-precisely, in order to re-echo an ultrasonic pulse 7′ in the direction of the test piece 3, in which the selection of the transducers, (here the transducers 2′) and the phase displacement of their activation influences the main propagation direction 6′ of the produced sound cone 7′ as well as its focusing. The coupling of the probe 1a, 1b, 1c, 1d to the surface of the test piece 3 takes place by means of “ROWA”-technology, i.e., in a rotating water jacket 4.

In FIG. 1, an implementation of the test cycle not according to the present invention is shown. As shown, through selection of the transducers 2′ without a phase displacement with its activation a main propagation direction 6′ of the reechoed ultrasonic pulse 7′ is attained, which is not perpendicular to the surface 5. Thus, at the bounding surface between water quench 4 and test piece 3 unforeseeable refraction effects occur, which bring into question the reliability of the testing method. Although such a propagation direction according to the present invention is not completely excluded, such a test cycle should nevertheless only additionally be implemented in the framework of the invention.

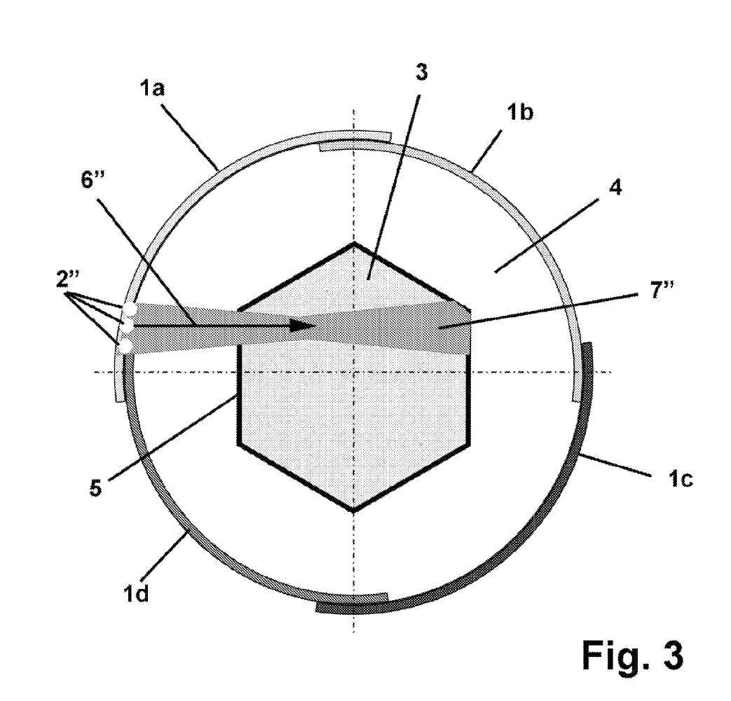

With FIGS. 2 and 3, the implementation of test cycles according to the present invention shall now be elucidated. In FIG. 2 a test cycle is shown, in which the transducers 2 are selected and activated, so that an ultrasonic pulse 7 is produced, whose main propagation direction 6 is perpendicular to the surface 5 of the test piece 3. A perpendicular penetration into the test piece 1 is achieved. With the selected transducers 2 and the nature of the phase activation, an ultrasonic pulse scanning the core of the test piece 2 by sound is achieved. The transducers 2 to be selected in the respective test cycle and their precise phase activation was determined before the implementation of the test cycles with a numerical analysis based on the arrangement relationship of the surfaces 5 of the test piece 3 and as possible all transducers of the probe 1a, 1b, 1c, 1d according to Fermat's Principle. The so-determined, arrangement-related specifications specify both the transducers 2 to be selected as well as their respective phase activation. Consequently, the relative arrangement between test piece 3 and probe 1a, 1b, 1c, 1d is to be retained during the testing. Due to the selective controllability of the transducers, depending on the desired propagation direction, the transducers spanning the antenna arrays can be activated. The number of the transducers to be activated in each cycle (typically 8-32 transducers—preferably 16) is in general to be determined in advance. Also, the phase activation serves the focusing of the transmitted ultrasonic pulse.

FIG. 3 shows the case of a further test cycle according to the present invention, in which the transducers 2″ are selected and their phase activation is selected, so that the main propagation direction 6″ of the ultrasonic pulse 7″ is parallel to the main propagation direction 6 in FIG. 2, in which another area, closer to the jacket area of the test piece 3, is scanned by sound and tested. Further test cycles can be provided, in which the remaining areas of the test piece 3 are tested, in which in each case corresponding transducers are selected and these are activated phase-precisely, so that the ultrasonic pulse re-echoed by these transducers has a main propagation direction, which is perpendicular to the respective surface. Thus, the main propagation direction of the produced ultrasonic pulse rotates with the time sequence of the test cycles.

1. Method for the non-destructive ultrasonic testing of a test piece (3) with flat surfaces (5) at an angle to each other by means of several selectively activatable ultrasonic transducers (2, 2′, 2″), whereby the method comprises several test cycles, with which certain (2, 2″) of the several ultrasonic transducers (2, 2′, 2″) are selected and activated, in order to emit at least one ultrasonic pulse (7, 7″) to the test piece (3), and with which the ultrasonic pulse reflected in the test piece (3) is received by the selected and/or, if necessary, other ultrasonic transducers (2, 2′, 2″), characterized in that in the respective test cycle said certain ultrasonic transducers (2, 2″) are selected and activated, so that the main propagation direction (6, 6″) of the ultrasonic pulse (7, 7″) produced by the selected and activated ultrasonic transducers (2, 2″) is perpendicular to at least one of the angled surfaces (5) of the test piece (3).

2. Method for the non-destructive ultrasonic testing of a test piece (3) with angled surfaces (5) according to the preceding claim, characterized in that the determined ultrasonic transducers (2, 2″) are selected and activated by means of the spatial arrangement relationship of the angled surfaces (5) to the several ultrasonic transducers (2, 2′, 2″).

3. Method for the non-destructive ultrasonic testing of a test piece (3) with angled surfaces (5) according to the preceding claim, characterized in that the selection and/or activation takes place by means of a numerical algorithm.

4. Method for the non-destructive ultrasonic testing of a test piece (3) with angled surfaces (5) according to one of the preceding claims, characterized in that a relative movement between the test piece (3) during the test cycle or between the test cycles and the ultrasonic transducers (2, 2′, 2″) is implemented while retaining the spatial alignment and the distance of its angled surfaces (5) to the ultrasonic transducers (2, 2′, 2″).

5. Method for the non-destructive ultrasonic testing of a test piece (3) with angled surfaces (5) according to one of the preceding claims, characterized in that the method comprises several time-sequential test cycles with main propagation directions (6, 6″) parallel to each other while testing different areas of the test piece (3).

6. Method for the non-destructive ultrasonic testing of a test piece (3) with angled surfaces (5) according to one of the preceding claims, characterized in that the method comprises several time-sequential test cycles for the testing of the test piece (3) while rotating the main propagation direction (6, 6″) in a circumferential direction of the test piece (3).

7. Device for the non-destructive ultrasonic testing of a test piece (3) with flat surfaces (5) at an angle to each other in several test cycles, whereby the device comprises: Several selectively activatable ultrasonic transducers (2, 2′, 2″), a selection unit for the selection of certain (2, 2″) of the several ultrasonic transducers (2, 2′, 2″) in each test cycle, a control unit for the activation of the selected ultrasonic transducers (2, 2″), in order to transmit at least one ultrasonic pulse (6) into the test piece, and an evaluation unit for the receipt of the ultrasonic pulse (7, 7″) reflected in the test piece through the ultrasonic transducers and/or other ultrasonic transducers, characterized in that the selection unit and/or the control unit are so designed, that in the respective test cycle said certain ultrasonic trans-ducers (2, 2″) are selected and activated, so that the main propagation direction (6, 6″) of the ultrasonic pulse (7, 7″) produced by the selected and activated ultrasonic transducers (2, 2″) is perpendicular to at least one of the angled surfaces (5) of the test piece (3).

8. Device for the non-destructive ultrasonic testing of a test piece (3) with angled surfaces (5) according to the preceding claim, characterized in that the selection unit and/or the control unit is so designed, that the determined ultrasonic transducers (2, 2″) are selected and activated by means of the spatial arrangement relationship of the angled surface (5) to the several ultrasonic transducers (2, 2′, 2″).

9. Device for the non-destructive ultrasonic testing of a test piece (3) with angled surfaces (5) according to the preceding claim, characterized in that the selection unit and/or the control unit are so designed, that the selection and/or activation is effected by means of a numerical algorithm.

10. Device for the non-destructive ultrasonic testing of a test piece (3) with angled surfaces (5) according to one of the preceding claims 7 to 9, characterized by a mechanism for the relative movement between the test piece (3) during or between the test cycles and the ultrasonic transducers (2, 2′, 2″) and by means for the retention of the spatial alignment and the distance of its angled surfaces (5) to the ultrasonic transducers (2, 2′, 2″).

11. Device for the non-destructive ultrasonic testing of a test piece (3) with angled surfaces (5) according to one of the preceding claims 7 to 10, characterized in that the selection unit and the control unit are so designed, that several time-sequential test cycles with main propagation directions (6, 6″) parallel to each other are provided for the testing of different areas of the test piece (3).

12. Device for the non-destructive ultrasonic testing of a test piece (3) with angled surfaces (5) according to one of the preceding claims 7 to 11, characterized in that the selection unit and the control unit are so designed, that several time-sequential test cycles are provided for the testing of the test piece (3) while rotating the main propagation direction (6, 6″) in a circumferential direction of the test piece (3).

13. Device for the non-destructive ultrasonic testing of a test piece (3) with angled surfaces (5) according to one of the preceding claims 7 to 12, characterized in that the ultrasonic transducers (2, 2′, 2″) are arranged ring-shaped, preferably spaced uniformly, around the test piece (3) to be tested.

14. Device for the non-destructive ultrasonic testing of a test piece (3) with angled surfaces (5) according to one of the preceding claims 7 to 13, characterized by a water quench (4), preferably a rotating water quench, between the ultrasonic transducers (2, 2′, 2″) and the surfaces (5) of the test piece (3) for the acoustic coupling.

15. Utilization of the device according to one of the preceding claims 7 to 14 for the testing of a rolled product as test piece (3), for example, made of high-speed steel or tool steel, preferably in the process of manufacture.

16. Arrangement of a device for the non-destructive ultrasonic testing according to one of the preceding claims 7 to 14, and a test piece (3) with angled, preferably in each case pairwise parallel surfaces (5).

17. Arrangement according to the preceding claim, characterized in that the test piece (3) is rod-shaped and the ultrasonic transducers (2, 2′, 2″) are arranged in a plane perpendicular to the longitudinal axis of the rod-shaped test piece (3).

18. Arrangement according to one of the two preceding claims, characterized in that the test piece (3) is a rolled product, for example, made of highspeed steel or tool steel.
